(19) United States
(12) Patent Application Publication
(10) Pub. No.: US 2023/0405980 A1
(43) Pub. Date: Dec. 21, 2023

(54) Low-Density Foam at Least Partially Covered with a Skin Material

(71) Applicant: NMC SA, Eynatten (BE)

(72) Inventors: Vincent Navez, Bonlez (BE); Silvain Meesen, Welkenraedt (BE); Gerhard Kriescher, Hergenrath (BE)

(21) Appl. No.: 18/253,223

(22) PCT Filed: Jul. 7, 2022
(86) PCT No.: PCT/EP2022/068982

§ 371 Date: May 17, 2023

(30) Foreign Application Priority Data
Jul. 14, 2021 (WO) PCT/EP2021/069636
Jul. 14, 2021 (WO) PCT/EP2021069636

(51) Int. Cl. B32B 27/06; B32B 5/18; B32B 7/02; B32B 5/32; B32B 27/30; C08J 9/36; C08J 5/12

(52) U.S. Cl. CPC B32B 27/065; C08J 2425/06; B32B 7/02; B32B 5/32; B32B 27/302; C08J 9/36; C08J 5/121; B32B 2307/72; B32B 2307/7376; B32B 2307/3065; B32B 2307/54; B32B 2307/558; B32B 2307/536; B32B 2266/0228; B32B 2307/546; B32B 2307/304; B32B 2307/102; B32B 2581/00; B32B 2451/00; B32B 2419/00; C08J 2325/06; B32B 5/18

(57) ABSTRACT

The present invention refers to a foam material with a low-density foam core wherein the foam core is at least partially covered with a skin material having a higher density than the foam core, which has a density of no more than 400 kg/m³ while the density of the skin material is at least 800 kg/m³.

The present invention refers to a foam material with a low-density foam core wherein the foam core is at least partially covered with a skin material having a higher density than the foam core, which has a density of no more than 400 kg/m³.

Low-density foam material is of increasing interest, in particular in the automobile industry as it allows a reduction of weight, which in turn results in reduced fuel consumption. Low-density foam material is equally appreciated in the building industry as it allows reducing the overall carbon footprint of buildings.

In order to protect the foam core and to improve its mechanical properties, the low-density foam material may be covered with a skin material.

U.S. Pat. No. 5,811,039 suggests a process for fabricating bodies of polymeric material, the process comprising the steps of: (a) preheating a sheet of thermoplastic polymeric material to a temperature greater than about 100° C., the sheet of thermoplastic material having a thickness of between about 0.5 to 20 mm; (b) transferring the sheet to a first half-mold; (c) thermoforming the sheet on the first half-mold; (d) positioning the first half-mold with the thermoformed sheet opposite to a second half-mold, so as to define a hollow chamber enclosed between the second half-mold and the thermoformed sheet; (e) injecting a mixture of (1) a foamable thermoplastic polymeric material compatible with the material which constitutes the thermoformed sheet and (2) one or more liquid hydrocarbons as foaming agents into the hollow chamber; the injection taking place in about two seconds or less, the hollow chamber having a pressure less than or equal to the surrounding atmosphere and the injected material being at a temperature sufficiently high to expand inside the hollow chamber and, once the injected material comes into contact with the surface of the thermoformed sheet, being substantially bonded to the thermoformed sheet by thermo welding; and (f) demolding the body. The foam such achieved has a density of 35 kg/m³.

U.S. Pat. No. 4,350,730 discloses a laminate suitable for use as a graphic arts board comprising two solid ABS resin sheets, said ABS resin comprising a pigment and UV stabilizer, said solid sheets being fusion bonded to the upper and lower surfaces of a foam resin core containing a blend of polystyrene and ABS resin, a nucleating agent, and an antistatic agent on the surfaces of the laminate. The foam core employed has a density of 24 to 96 kg/m³.

U.S. Pat. No. 4,469,733 refers to a foam sandwich structure suitable for use as a load bearing cladding with high stiffness to weight ratio and being of the type in which two skins are resin-bonded, one on each side, to a core of plastics foam material to form the sandwich with said core forming the main means of shear stress transference between the two skins, the improvement comprising: (a) each skin comprising a layer of monofilaments of at least 10 cm in length laid substantially in parallel with one another to extend along the skin, with directional change being kept minimal, said skin monofilaments being non-sinuous and not woven; (b) a mat of randomly arranged monofilaments interposed between the foam core and each adjacent monofilament skin layer; and (c) said filaments of said skin and said mat being bound to one another and to adjacent layers of the sandwich structure by a thermosetting resin, wherein the resin is present in a quantity sufficient to wet the filaments but not in excess, the ratio of resin to monofilament being less than 1.75:1 by weight throughout the layer of monofilaments forming each skin, and the ratio of resin to monofilament being less than 2:1 by weight throughout the sandwich structure as a whole, whereby a sandwich structure of improved load bearing strength is provided. The density of the foam core is at least 75 kg/m³.

WO 2020/065564 A composite foam article comprising: a polyurethane foam core presenting a first surface and a second surface facing opposite said first surface, a first skin disposed on said first surface comprising a plurality of fibers and a polymeric binder; a second skin disposed on said second surface comprising a plurality of fibers and a polymeric binder; and at least one additional layer comprising an ethylene acrylic acid (“EAA”) copolymer dispersed in and/or disposed between any of said aforementioned skins and core. The density of the polyurethane foam ranges from 22 to 80 kg/m³.

US 2011/0293914 A method to manufacture a shaped foam composite article comprising a foam core and one or more skin comprising the steps of: (A) preparing a foam core by the steps comprising: (i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4 and (ii) forming a foam blank from the foam plank by preparing one or more pressing surface, (B) applying one or more skin onto one or more surface of the foam core, and (C) providing shape to the foam core, wherein the skin(s) conform to the shape of the foam core providing a shaped foam composite article. Suitable foam densities are preferably equal or less than 160 kg/m³, in particular less than 100 kg/m³.

However, the advantage of the reduced weight of low-density foam material is usually accompanied by a number of drawbacks, such as a reduction in flexural strength and Shore hardness, which limits the application of such materials.

The problem has been addressed by coextruding a cover layer onto the foam. However, co-extrusion of low-density foam is still a challenge which requires careful control of pressure and temperatures, as described in EP 0 553 522. According to said document, the temperature should not be too hot to avoid collapsing the foam, nor so cold as to restrict expansion of the foam. Also, the pressure must be sufficiently high to prevent premature foaming, prior to exiting the die. Therefore, the viscosity of the composite streams has to be carefully controlled and adapted for each material composition.

DE 10 2019 110 423 suggest a composite profile piece comprising a foam core which is foamed in air to a density of up to 250 kg/m3 and which comprises at least one functional element on one of its sides which has been applied by means of co-extrusion.

Although the suggestions of the prior art offer a solution to the question of how the hardness of foam materials may be improved, the increase in hardness is usually accompanied by a loss of flexural strength, so that no acceptable compromise has been found so far.

Therefore, there still exists the need for low-density foam material with physical properties comparable to those of materials of higher density, in particular with regard to Shore hardness and flexural strength.

It was surprisingly found that this need can be addressed by a foam material with a low-density foam core, in particular a foam core with a density of no more than 400 kg/m³, wherein the foam core is at least partially covered by a skin material which has a higher density than the foam core.

A first object of the present invention is therefore a foam material with a low-density foam core wherein the foam core is at least partially covered with a skin material, which has a higher density than the foam core and wherein the density of the foam core is no more than 400 kg/m³ and wherein the density of the skin material is at least 800 kg/m³.

Within the course of the present invention, the density was generally determined according to DIN 53479.

Surprisingly, the inventive foam material was found to show the advantage of reduced weight of low-density foams while the skin covering provided a sufficient Shore hardness while having a minimal effect on the flexural strength.

In a preferred embodiment, at least one surface of the foam core is covered by the skin material. In a further preferred embodiment, at least two opposite surfaces of the foam core are covered by the skin material.

The present invention in particular focuses on low-density foams. Therefore, in a preferred embodiment, the foam core has a density of no more than 325 kg/m³, more preferably of no more than 300 kg/m³, especially no more than 250 kg/m³.

In a preferred embodiment, the foam core has a density of more than 40 kg/m³, preferably more than 50 kg/m³, more preferably more than 60 kg/m³. Particular preference is given to foam cores having a density of 40 to 400 kg/m³, preferably 60 to 300 kg/m³.

The inventive concept can be applied to a variety of different foam cores. In a preferred embodiment, the foam core is made from a polymer selected from the group consisting of polystyrene (PS), high-impact polystyrene (HIPS), polyethylene terephthalate (PET), polypropylene (PP), high-density polyethylene (HDPE), acrylonitrile butadiene styrene (ABS), styrene-butadiene blockcopolymer (SBS), styrene ethylene butylene copolymer (SEBS), and their blends. In a particular preferred embodiment, the foam core is extruded polystyrene (XPS).

The inventive foam material further has the advantage that recycled polymers can be used for making the foam. Any optical degradation due to the use of recycled material are compensated by covering the surface of the foam with the skin material. Therefore, an embodiment is preferred wherein the foam material contains at least 20 wt.-% of recycled polymer, preferably at least 40 wt.-% and in particular at least 60 wt.-%, based on the total weight of the foam material, respectively. In a particular preferred embodiment, the foam material, especially the foam core, is made entirely of recycled polymer.

The advantageous properties of the inventive foam material are in particular achieved by combining a low-density foam core with a higher-density skin material. In a preferred embodiment, the skin material has a density of at least 1000 kg/³, especially at least 1100 kg/m³. Surprisingly, covering the low-density foam core with the higher-density skin material allows for a favorable combination of low weight and hardness. In a preferred embodiment, the density of the skin material is at least twice the density of the foam core. More preferred is a density of the skin material, which is at least three times higher than the density of the foam core.

The inventive foam material combines the advantage of low weight with a high hardness without loss of flexibility. In a preferred embodiment, the foam material has an overall density, i.e. with skin covering, of less than 500 kg/m³, preferably 100 to 400 kg/m³, more preferably 150 to 250 kg/m³.

The skin material is preferably adapted to the foam core. In a preferred embodiment, the skin material is selected from the group consisting of polystyrene (PS), high-impact polystyrene (HIPS), polyethylene terephthalate (PET), polypropylene (PP), high-density polyethylene (HDPE), poly(p-phenylene oxide (PPO); polyvinylchloride (PVC), acrylonitrile butadiene styrene (ABS), styrene-butadiene blockcopolymer (SBS), styrene ethylene butylene copolymer (SEBS) as well as their blends. A particular preferred material for the skin material is extruded polystyrene (XPS). In an alternatively preferred embodiment, the skin material is high-impact polystyrene (HIPS). The skin material can be either a solid material or a slightly foamed material. In a preferred embodiment, the skin material may comprise one or more reinforcing agents, preferably glass fibers.

The thickness of the skin material covering the foam core may be adapted according to need. However, in order to ensure the required hardness of the skin material while maintaining the flexibility of the low-density foam, the thickness of the skin material is preferably 100 to 2000 μm, more preferably 150 to 1000 μm and in particular 300 to 700 μm.

The inventive concept further provides the advantage that the skin material may be applied to only one side of the foam core, thus saving material costs. As the inventive foam material may be used as floor or wall covering, it is preferred that at least any side visible after installation is covered with the skin material.

The inventive foam material shows a number of advantageous and surprising properties, which will be described in more detail below. It is to be understood that in case the foam core is only partially covered by the skin material, the values given refer to the covered part of the foam core.

The inventive foam material further provides the advantage that the properties of the foam core, and thus the properties of the foam material, may be adapted according to need without affecting the optical properties. For example, flame retardants can be added in order to improve the safety measures and meet respective regulations. Therefore, in a preferred embodiment, the foam material is characterized by a fire resistance of at least class E s1 d0, preferably at least D s1 d0, most preferably at least C s1 d0, determined according to EN 13501-1, respectively.

The inventive foam material can be produced by extrusion, in particular by extruding the skin material directly onto the foam core via co-extrusion. Without being bound by theory, it is believed that the co-extrusion process creates a strong interface between the foam core and the skin material, allowing for the advantageous properties of the inventive foam material.

The conditions for producing the foam core and co-extrusion depend on the nature of the material as well as the gas used for foaming and can be adapted according to need by the person skilled in the art. In cases of amorphous polymers being used as foam material, the foaming temperature is preferably selected to be above the glass transition temperature (T_{g}) of the polymer. In an especially preferred embodiment, the foaming temperature is selected to be at least 25° C., preferably at least 30° C., in particular at least 40° C. above the glass transition temperature of the polymer. In cases of semi-crystalline or crystalline polymers, the foaming temperature is preferably selected to be above the crystallization transition temperature and preferably between the crystallization temperature (T_{c}) and the melting temperature (Tₘ) of the polymer. Glass transition temperature (T_{g}), crystallization temperature (T_{c}) and melting temperature (Tₘ) can be determined according to standard methods and depicted from scientific tables.

For applying the skin material, the mass temperature of the skin material is preferably selected to be above the foaming temperature. In case of amorphous polymers, the mass temperature of the skin material is preferably at least 5° C. higher than the foaming temperature, in particular 7 to 20° C. above the foaming temperature. In cases semi-crystalline or crystalline polymers are employed as skin material, the mass temperature of the skin material during extrusion is preferably chosen to be at least 5° C. above the respective foaming temperature, in particular 15 to 35° C. above the foaming temperature.

In the course of the present invention, it was surprisingly found that the physical properties of a low-density foam core could be drastically improved by providing at least one surface of the foam with a skin material of higher density than the foam thus improving the hardness of the inventive foam material without affecting the elasticity of the foam core. In a particular preferred embodiment, the foam material is characterized by an E-modulus according to ISO 178 of at least 0.1 GPa, preferably at least 0.3 GPa, most preferably at least 0.5 GPa.

Further preferred is an embodiment wherein the inventive foam material according to the invention has a flexural strength according to ISO 178 (23° C., 50% RH, 20 mm/min) of at least 1.5 MPa, preferably at least 5 MPa, most preferably at least 10 MPa.

Also preferred is an embodiment of the present invention wherein the foam material shows no visible impact in the Wegner test at 15 Newton, according to DIN 53799.

The inventive foam material is in particular characterized by its surprising hardness despite its low density and weight. In a preferred embodiment, the foam material has a Shore 0 hardness of at least 40, preferably of at least 50, most preferably of at least 60, determined according to ASTM D 3240.

Further, the foam material has a Shore D hardness of at least 60, preferably at least 70, most preferably of at least 80, determined according to DIN 53505.

The foam material according to the invention can be used in a number of applications. A further object of the present invention is therefore the use of an inventive foam material in applications of thermal insulation and/or sound insulation, sealing, damping for the purpose of weakening or canceling oscillations or vibrations, stiffening, as structural elements and/or those that serve to seal doors, windows and facades or for decorative purposes, in particular in the construction industry, in the automotive sector and in aviation. In a particular preferred embodiment, the inventive foam material is used in decorative molding and/or as base boards, in particular as skirting.

### EXAMPLES

The present invention will be described in more detail with reference to the following examples which by no means are to be understood as limiting the scope and spirit of the present invention.

Several samples of inventive foam material having a thickness of 12.8 mm and a width of 38 mm were prepared using a foam core of GPPS foamed at a temperature of 155° C. with a density of 200 kg/m³. The samples were covered with a skin of high-impact polystyrene of different thickness by co-extruding the foam core and skin material at a temperature of 170° C. and the mechanical properties were analyzed. For comparison, the properties of a low-density foam of GPPS having a density of 200 kg/m³ (Comp. 1) and 400 kg/m³ (Comp. 2), respectively, without skin cover are provided.

### Methods

The density was determined according to DIN 53479

The Shore D hardness was determined according to DIN 53505.

The E-modulus was determined according to ISO 178.

The flexural strength was determined according to EN 12089.

The inventive foam materials were prepared by extrusion. As can be seen from the data provided in Table 1, the foam material according to the present invention (Ex.-1, Ex.-2 and Ex.-3) provided an excellent combination of properties with an improved Shore D hardness compared to foams without skin material (Comp. 1 and Comp. 2), while at the same maintaining the other mechanical properties.

TABLE 1

| | Skin | overall | | | Flexural |
|---|---|---|---|---|---|
| | thickness | density | | E-Modulus | Strength |
| Example | [μm] | [kg/m³] | Shore D | [MPa] | MPa] |
| Ex .-1 | 500-630 | 244 | 67 | 664 | 11.9 |
| Ex .-2 | 390-400 | 230 | 58 | 613 | 11.6 |
| Ex .-3 | 440-500 | 236 | 63 | 655 | 12.1 |
| Comp. 1 | — | 206 | 27 | 446 | 8.4 |
| Comp. 2 | — | 385 | 55 | 770 | 14.2 |

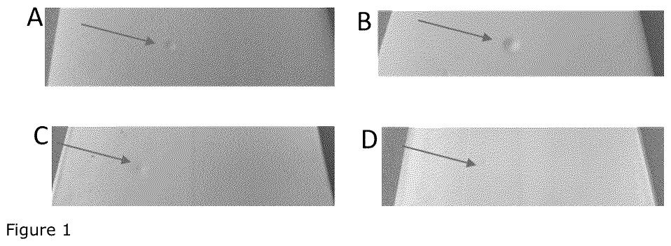

Further, the inventive foam materials showed no visible dent after the Wegner Test according to DIN 53799, while the foams used in Comp 1 and Comp 2 clearly showed the place of impact at 15 Newton. The results of the Wegner Tests are shown in FIG. 1 with pictures A and B depicting common foams of 200 kg/m³ and 400 kg/m³, respectively, without a cover, while pictures C and D show examples of the inventive foam material. As can be clearly seen, almost no impact mark is visible in case of the inventive foam material.

1. A foam material with a low-density foam core, wherein the foam core is at least partially covered with a skin material, characterized in that a density of the skin material is higher than a density of the foam core and the density of the foam core is no more than 400 kg/m³, and wherein density of the skin material is at least 800 kg/m³.

2. The foam material according to claim 1, further characterized in that the density of the foam core is higher than 40 kg/m³.

3. Foam material according to claim 1, characterized in that an overall density of the foam material is less than 500 kg/m³.

4. The foam material according to claim 1, characterized in that the foam core is made of a polymer selected from the group consisting of polystyrene (PS), high-impact polystyrene (HIPS), polyethylene terephthalate (PET), polypropylene (PP), high-density polyethylene (HDPE), acrylonitrile butadiene styrene (ABS), styrene-butadiene blockcopolymer (SBS), styrene ethylene butylene copolymer (SEBS), and their blends.

5. The foam material according to claim 4, characterized in that the foam material is at least partially obtained from at least 20 wt.-% of a recycled polymer.

6. The foam material according to claim 1, characterized in that the density of the skin material is at least 1000 kg/m³.

7. The foam material according to claim 1, characterized in that the skin material is selected from the group consisting of polystyrene (PS), high-impact polystyrene (HIPS), polyethylene terephthalate (PET), polypropylene (PP), polyethylene (PE), high-density polyethylene (HDPE), poly(p-phenylene oxide (PPO), polyvinylchloride (PVC), acrylonitrile butadiene styrene (ABS), styrene-butadiene blockcopolymer (SBS), styrene ethylene butylene copolymer (SEBS) as well as their blends.

8. The foam material according to claim 1, characterized in that the skin material is a solid material or a slightly foamed material.

9. The foam material according to claim 1, characterized in that the thickness of the skin material is 100 to 2000 μm.

10. Foam material according to claim 1, characterized in that the foam material has a fire resistance of at least class E s1 d0, determined according to EN 13501-1.

11. The foam material according to claim 1, characterized in that the foam material has an E-modulus according to ISO 178 of at least 0.1 GPa.

12. The foam material according to claim 1, characterized in that the foam material has a flexural strength according to ISO 178 (23° C., 50% RH, 20 mm/min) of at least 1.5 MPa.

13. The foam material according to claim 1, characterized in that the surface of the foam core covered by the skin material shows no visible impact in the Wegner test at 15 Newton according to DIN 53799.

14. The foam material according to claim 1, characterized in that the foam material has a Shore 0 hardness of at least 40, determined according to ASTM D 3240.

15. The foam material according to claim 1, characterized in that the foam material has a Shore D hardness of at least 60, determined according to DIN 53505.

16. A product containing the foam material according to claim 1, the product comprising thermal insulation, sound insulation, a sealing material, a damping material for the purpose of weakening or canceling oscillations or vibrations, a stiffening material, a structural element, a door seal, a window seal, a façade seal, a product for decorative purposes, or a base board.
